(19) United States
(12) Patent Application Publication
(10) Pub. No.: US 2011/0297809 A1
(43) Pub. Date: Dec. 8, 2011

(54) PROJECTOR MOUNT WITH MICRO ADJUSTMENT

(76) Inventors: Michael F. Bouissiere, Yorba Linda, CA (US); Leonard Dozier, Yorba Linda, CA (US)

(21) Appl. No.: 12/796,018

(22) Filed: Jun. 8, 2010

(51) Int. Cl. F16M 13/00

(52) U.S. Cl. 248/274.1

(57) ABSTRACT

The present invention involves a projector mount and micro adjustment capability which allows a projector to be mounted to fixed object (f ex ceiling), rough adjustment to be made with the ceiling mount and then fine adjustments to be made by a micro adjusting mechanism. The micro adjustor provides for a fluid pitch, yaw and roll adjustment without hanging up in place, which might throw off the adjustments. An installation and alignment tool is also provided. A method of adjustment and installation is also disclosed.

### FIELD OF THE INVENTION

This disclosure relates of the field of projector mounts, particularly ceiling or wall mounted projectors used to project images on a distant surface.

### BACKGROUND OF THE INVENTION

For the purposes of projecting a video recording or data, there are advantages to having a projector mounted well above the head height of a standing viewer. Typically in a hotel, conference center or viewing room a mounting bracket at a relatively high locations provides for a projector attached to it to display on a screen without the projected image being interrupted by the passage of a late arrival. However the provision of a high mounting bracket can cause access and alignment problems when a projector is mounted by means of a single bracket. In addition, a proper alignment system should allow for the ready alignment of an attached projector. The system should also provide for ready mounting and dismounting of the projector when the projector is not used for a period of time. This permits the projector to be readily removed from the mounting system, and stored in a secure environment. It also provides for easy off site maintenance. In US published patent application US 20090108150, we (ie common assignee herewith) disclosed a system for mounting and leveling a projector.

This system provides a convenient way to adjust the position of the projector mount with respect to the fixed object (ceiling, wall, etc), but it does not take into account that sometimes it is necessary to swap out different projectors. This swap can occur because of maintenance (bulb), upgrade, or different projection characteristics are required.

Furthermore, impact to the mount can through the alignment with the screen off and it would be desirable to be able to readjust the projector aim, without disturbing the basic mount to the fixed structure and without special tools. Wobble must also be avoided. That is the mount must be adjustable to a desired aim, and stay in place despite building movements from HVAC and other forces. Often ceiling projector mounts are difficult to reach, so realignment must be “set and forget” to the greatest extent possible.

Further aggravating a solution to this problem, is the need for the adjustment to be possible in all planes (x,y,z ie pitch, yaw and roll) in a very compact unit which is completely fluid (non seizing) in response to adjustment yet does not require lubrication or resulting in lubricants dripping on the projector. Such dripping could result in a fire as the projector is extremely hot when in use.

The fluidity of adjustment, ie smooth non jerky movement, is critical because any force applied to the mount can easily cause other elements of the mount to deform and thus the adjustment must be restarted, possible at the base adjustment of the mount to the fixed element.

Therefore, there is a need for a precision micro adjustable mount with pitch, yaw and roll micro-adjustment with smooth movement and no wobble.

### SUMMARY OF THE INVENTION

To assist the reader in preparing to digest the detailed description and claims below, a short summary has been provided. It is far from complete and only provides a glimpse of the invention concepts. It is not intended to define the scope of the invention. The claims perform that function.

As mentioned above, there are many more features and embodiments. Reference should be had now to the detailed description and claims which follow.

### BRIEF DESCRIPTION OF THE SEVERAL VIEWS OF THE DRAWINGS

An exemplary embodiment of the invention will now be described with reference to the accompanying drawings of a projector mount:

FIG. 1 is a top perspective view of the mount, mount receiving plate, mounting plate and articulatable legs.

FIG. 2. is a top perspective view of the mount aligned to insertion into a mount receiving plate.

FIG. 3 is a bottom perspective view of the mount and insertion/alignment tool.

FIG. 4 is a bottom perspective view of the mount.

FIG. 5 is a top perspective view of the mount, insertion tool and socket wrench.

FIG. 6 is a bottom perspective view of the insertion alignment tool.

FIG. 7 is a bottom perspective of the insertion tool used for mounting.

FIG. 8 is a perspective view of the mount.

FIG. 9 is a side plan view of FIG. 9.

FIG. 10 is a top plan view of the mount.

FIG. 11 is a side plan view like FIG. 9 rotated 90 degrees.

FIG. 12 is a top plan view of the mount and mount receiving plate and the mounting plate.

FIG. 13 is a view along line C-C of FIG. 12.

FIG. 14 is a side plan view like FIG. 11 rotated 90 degrees.

FIG. 15 is a view along Fig. A-A.

FIG. 16 is an exploded top perspective view of the mount.

FIG. 17 is a view like FIG. 16 rotated 90 degrees.

FIG. 18 is a view like FIG. 17 rotated a further 90 degrees.

FIG. 19 is an exploded bottom perspective view.

### DETAILED DESCRIPTION

This disclosure relates to a system and method for micro adjustment of equipment which is mounted to a fixture/fixed surface. The most common type of equipment is a projector, screen or similar device, though this disclosure is not limited to such equipment, but to any item where fine adjustment of its position with respect to a fixed surfaces is desired. Further, the fixed surface may actually be mobile. The term is used as a reference point to some place the equipment is to be mounted, most often it is a wall or ceiling.

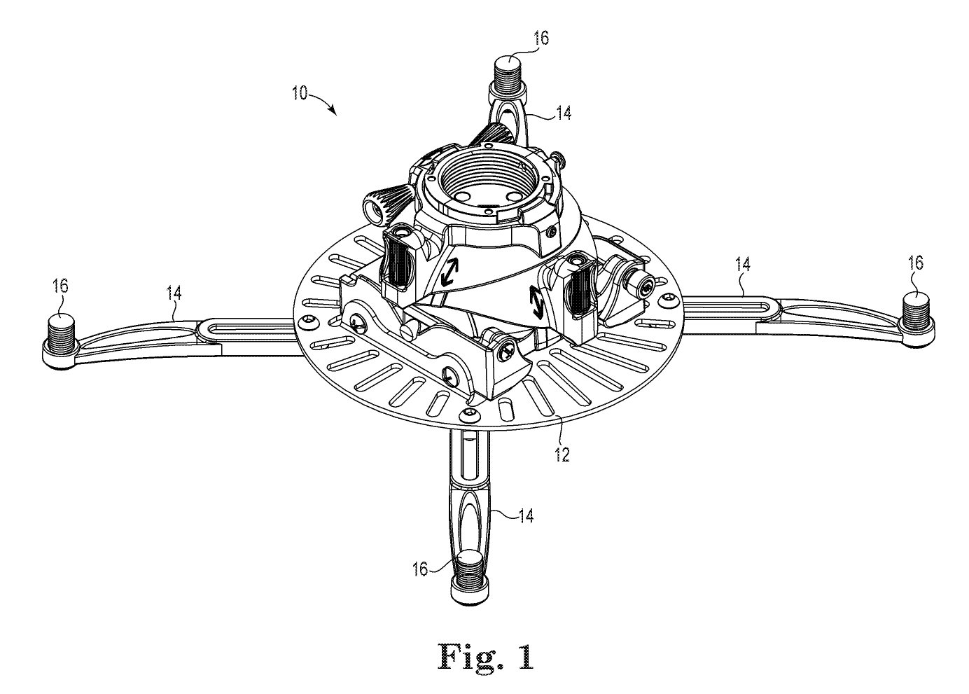

FIG. 1 illustrates a mounting system 10, having a circular support plate 12, with a plurality of articulatable legs 14 each having leveling barrels to be affixed to a piece of equipment, such as projector, not shown. The function of theses parts can be seen in US patent publication US 20090108150, which is incorporated herein by reference.

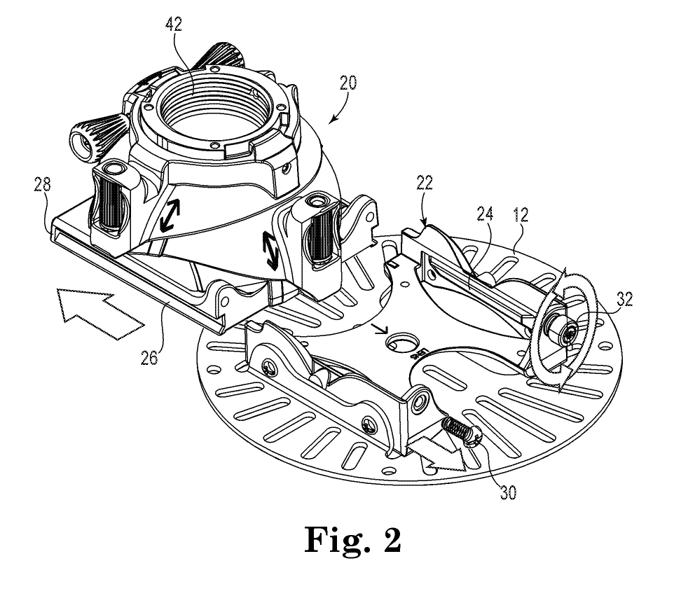

FIG. 2 shows a close up of the mount unit 20 being slideable received within a optional slide release mount plate 22. Mount plate 22 has a pair of spaced apart opposing rails 24 which receive like rails 26 on the mount unit 20 to a stop 28. For safety, a lock fastener 30 is provided as well as a quick release knob 32. In the preferred embodiment, both must be removed to slide the unit out.

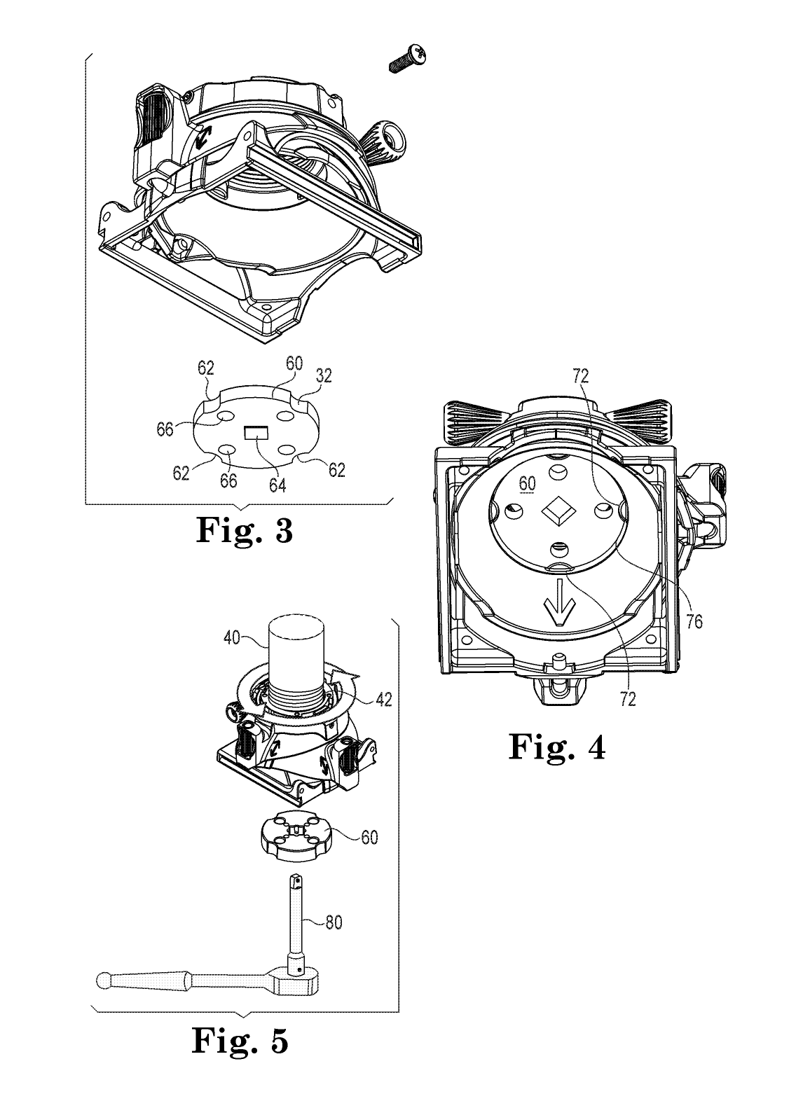

FIGS. 3-7 relate to various ways to mount unit 20 and a tool therefore.

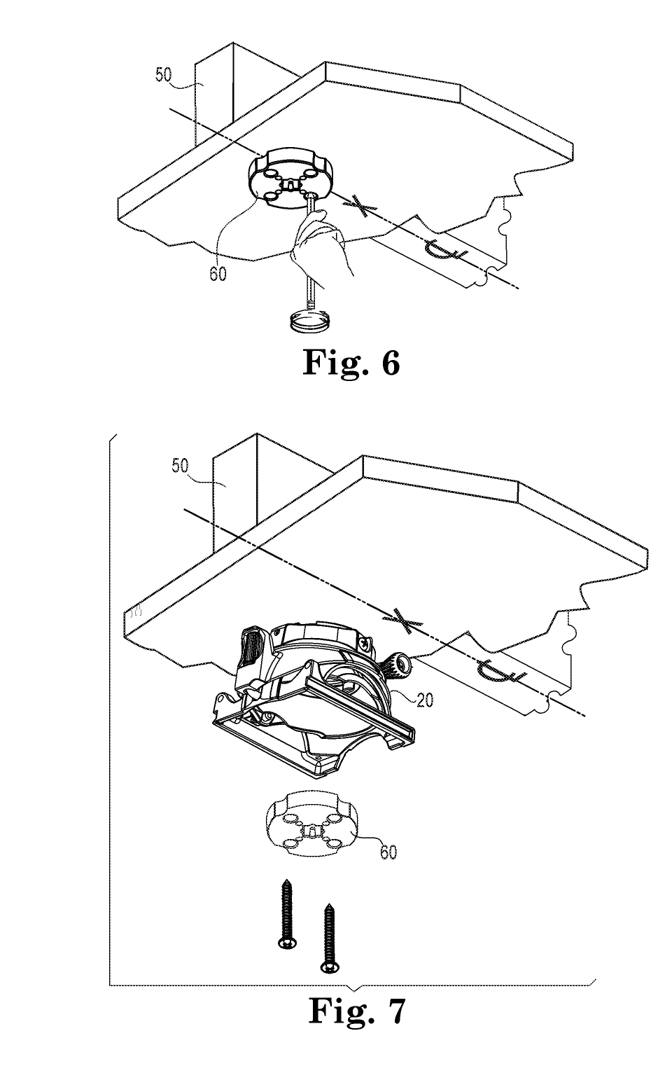

The mount unit 20 is often mounted to a threaded pipe 40 (FIG. 5) but may also be mounted to a joist/stud 50 (FIG. 6) or other solid point.

When mounted to a pipe, the mount unit 20 includes a threaded aperture 42 (FIG. 1), which engages the pipe. The typical way to attach a mount to a pipe is by using wrench to twist the mount unit 20 onto the pipe, but this will either mar or damage the unit. Therefore a multipurpose tool has been created to solve this and joist mounting.

Tool 60 is a disk is typically circular though any shape is possible. On its peripheral edge are at least one and preferably a plurality of engagement points 62, usually notches used to engage the mount unit. Also included is a least one tool receiving ports 64 and optionally mounting holes 66.

The mounting unit 20 has a set of mating engagement points 72 (FIG. 4) which are sized an spaced apart to receive points 62. In the preferred embodiment, there is a ring 76 in the inner surface of the mounting unit with projections 72 to mate with recesses 62 (recesses and projections can be swapped). A tool 80 (FIG. 5) is used to turn the mounting unit 20 via the disk 60 onto the pipe. This can be done with no visible damage or distortion of unit 20.

In the case where unit 20 is attached to a joist/stud 50, disk 60 first functions as a marking disk as shown in FIG. 6 where mounting holes can be marked with the disk before drilling and then the mounting unit 20 itself can be screwed into place.

Thus it can be seen that the disk 60 functions as a multi-tool for tightening and for mounting. The tool can be characterized as a combination and tightening tool system for affixing a projector mount to a fixed surface where the mound has a collar for a threaded pipe and a central aperture defining a central axis. The inner surface of the disk has a plurality of engagement members spaced around and a like mating set on the aperture. The tool is sized and shaped to be removeably received within the inner surface of the mount and having mating members sized and shaped to received the engagement members. Preferably the tool including a central keyed aperture sized to receive a cranking tool and at least one other aperture therethrough, though it could be cranked by other connections to the disk such as hooks etc.

A method of attachment and tightening is also disclosed using the steps of including mating engagement members on the mount and a disk, engaging the disk and turning the disk to drive the mount onto a threaded pipe or engaging the disk and fastening the disk to a fixed surfaces thereby capturing the mount between the disk and surface.

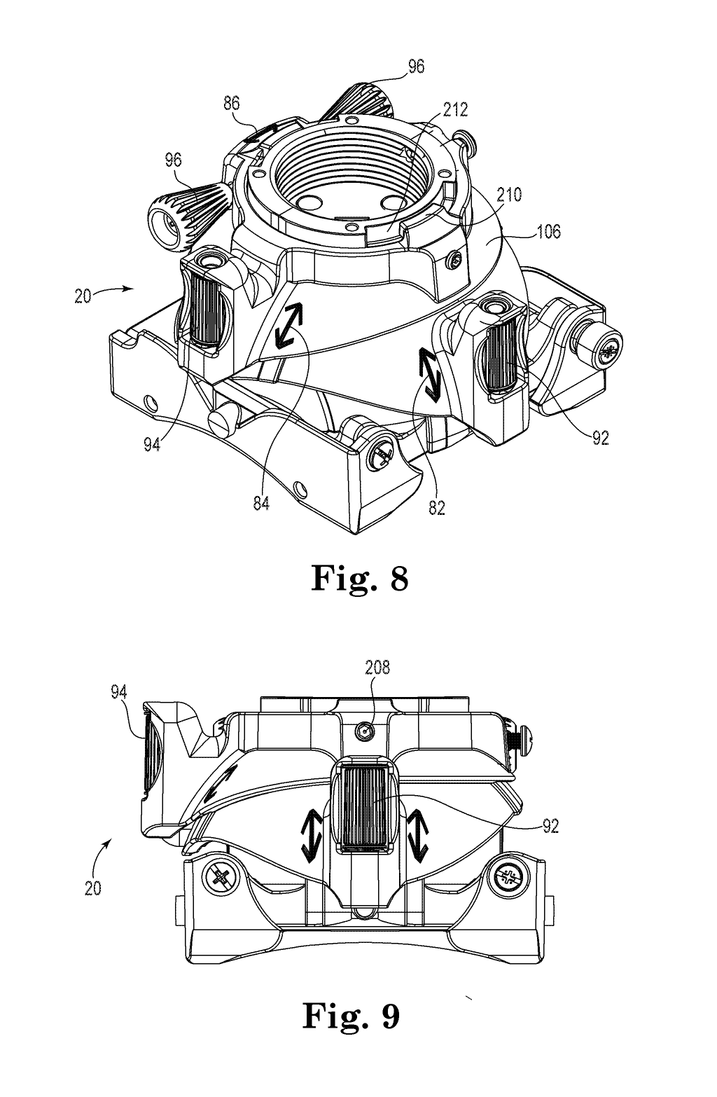

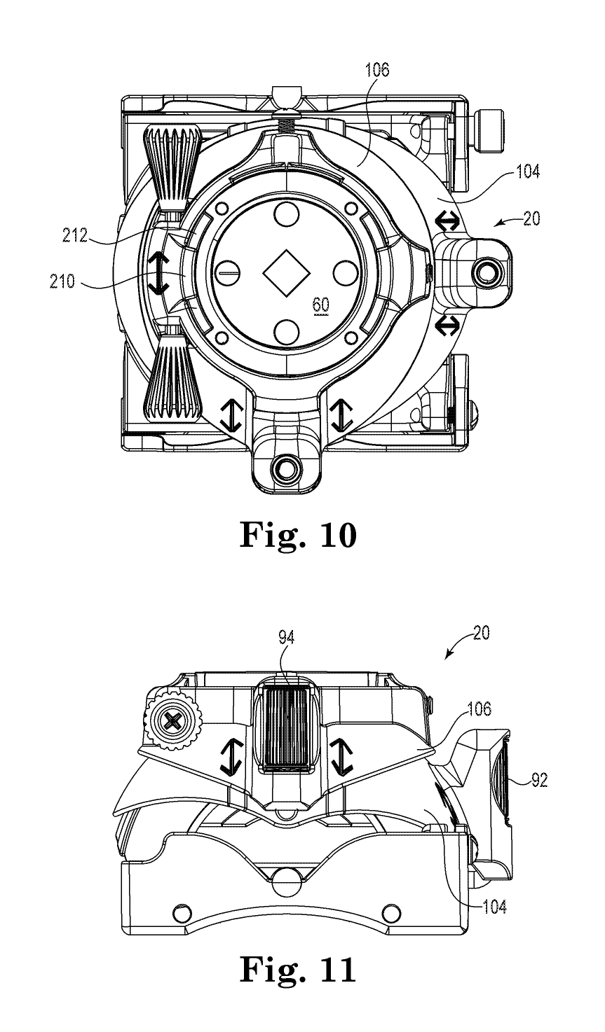

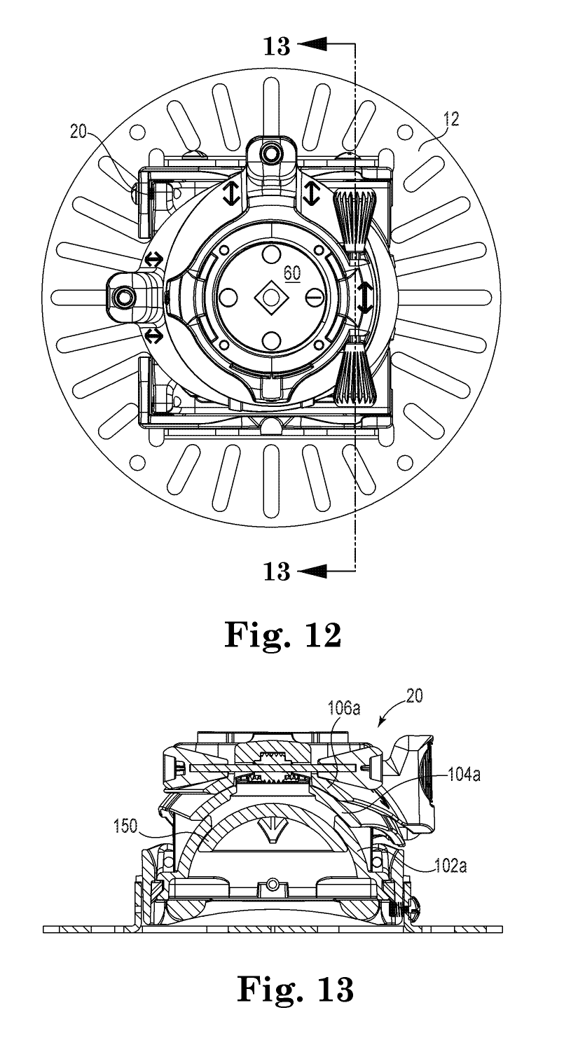

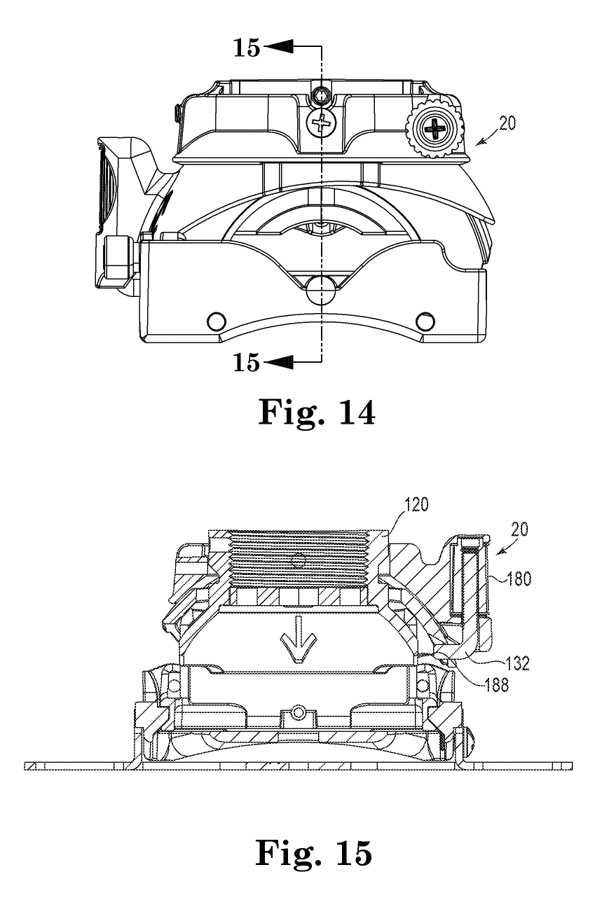

Turning to FIGS. 8-21, the operation of the mounting unit and method of micro adjusting will be explained.

FIGS. 8-15 show the mounting unit in various views and with portions broken away or on section lines.

Arrow 82-86 show the various directions of movement possible by this mount. Arrow 82 showed movement in the X direction (or pitch), arrow 84 shows movement in the Y direction (or Yaw) and arrow 86 shows rotating movement (Roll).

Each of these movement are accomplished by separate knurled controls 92, 94, and 96 respectively.

In a broad sense, this is how the micro adjustments work.

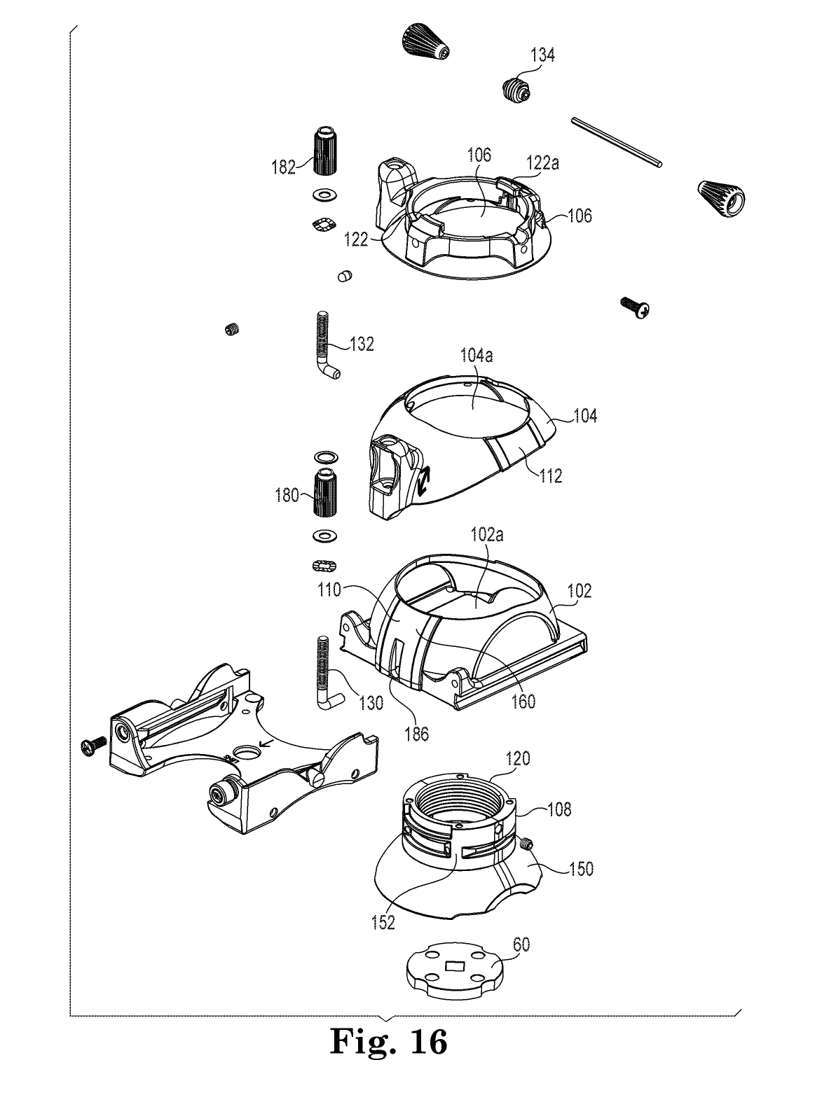

The preferred embodiment has a domed hemispherical base element (102 FIG. 16), having an inner and outer surfaces and a generally central aperture 102a. The second hemispherical intermediate element (104) also has an inner and outer surfaces the inner surface being sized to receive said outer surface of said base element 102 therein, in contact therewith and having a generally central aperture 104a. There is a third hemispherical top element 106 which has inner and outer surfaces, said inner surface sized to receive said outer surface of said intermediate element 104 in slideable contact therewith and having a generally central aperture 106a. Then there is a central collar element 109 which has a generally cylindrical portion sized to be received thru said central apertures, and a hemispherical outer surface sized to be received at least partly within and in slideable relation with the inner surface of the base element. FIG. 13 shows how the various surfaces rest upon each other to allow pitch, yaw and roll independent movement.

To insure that each element moves in the intended direction, there are guides 110. The first guides 110 are located between said base 102 and intermediate 104 elements for limiting the movement between said elements along the path defined by the first guides, thereby defining movement in a first orientation—ie pitch. A second set of guides. 112 is located between said intermediate and top elements for limiting the movement between the elements along a path defined by said second guides, thereby defining movement in a second orientation (yaw). A third guides 120 on the collar 108 and 122 on the top element 106, amongst other guiding elements are located between said top and collar elements for limiting the movement between the elements along a path defined by the second guides, thereby defining movement in a third orientation (roll).

Further refinements may be a first continuous screw adjustable link 130 between said base and intermediate elements, the link configured to move said base and intermediate elements relative to each other along the path of said first guide. A second continuous screw adjustable link 132, offset from the first link by 90 degrees, between the intermediate 104 and top elements 106, the link configured to move said intermediate and top elements relative to each other along the path of said second guide 112 and a third continuous screw adjustable link 134, offset from at least one of said first or second links by 90 degrees, between said collar 108 and top 106 elements, said links configured to move said collar and top elements relative to each other along the path of the third guide, so that movement of each link controls the positioning of the collar in pitch yaw and roll orientations.

Of course, the above explanation includes non-essential elements and the full operation will be explained below.

The basis structure of the preferred embodiment can be seen in FIGS. 8-21 and in particular FIGS. 8 and 16. The central collar unit 108 is the portion which is affixed to a ceiling or other fixed structure. It essentially “floats” within the other shell elements and its positioning guides and adjusters as will be explained below.

Collar unit 108 has a hemispherical portion 150 which includes a hemispherical flange having a central aperture and a collar stem 152 extending upwardly therefrom also having an aperture and co-axially aligned therewith. To facilitate continuous (ie smooth, not jerky) adjustment, the flange portion at least is coated with non-stick surface material which self lubricates parts which much slide across each other. Therefore, all hemispherical surfaces of the various parts are preferably coated with a non-stick fixed (non liquid) coating. This prevents the parts from “hanging” which would make micro adjustment impossible. (Keep in mind that in a projector, a fraction of a mm movement at the mount, will make centimeters of movement on the projector screen, so precise fluid micro adjustment is critical).

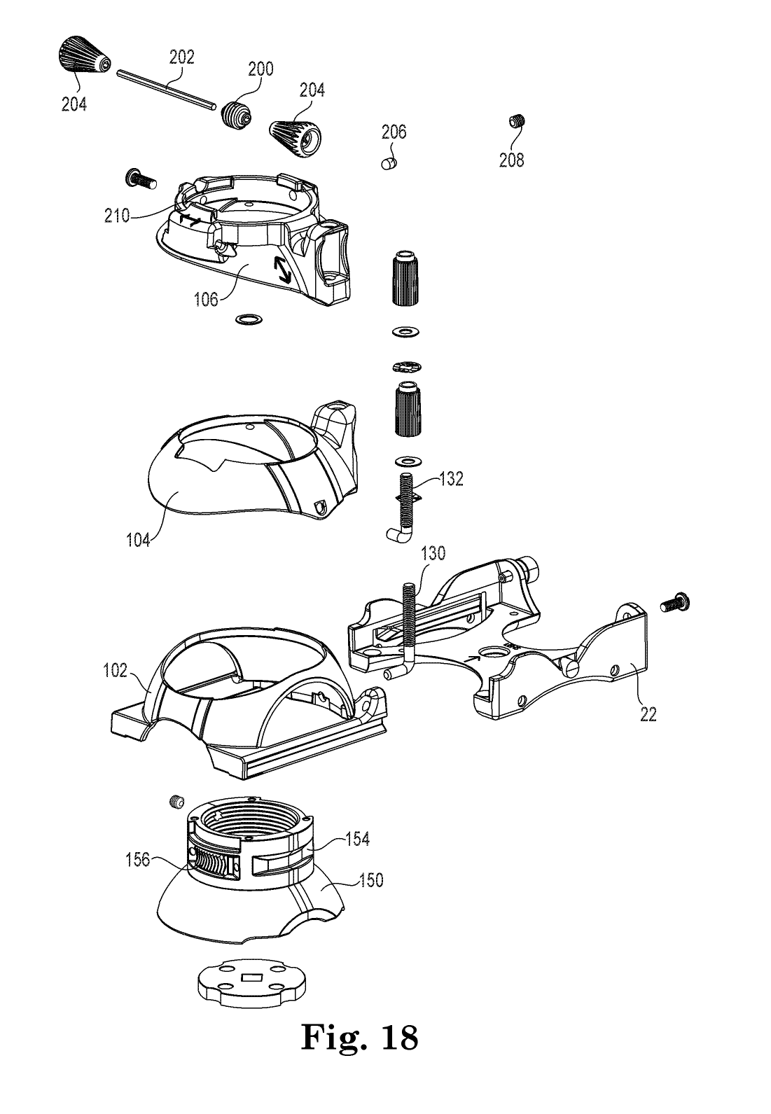

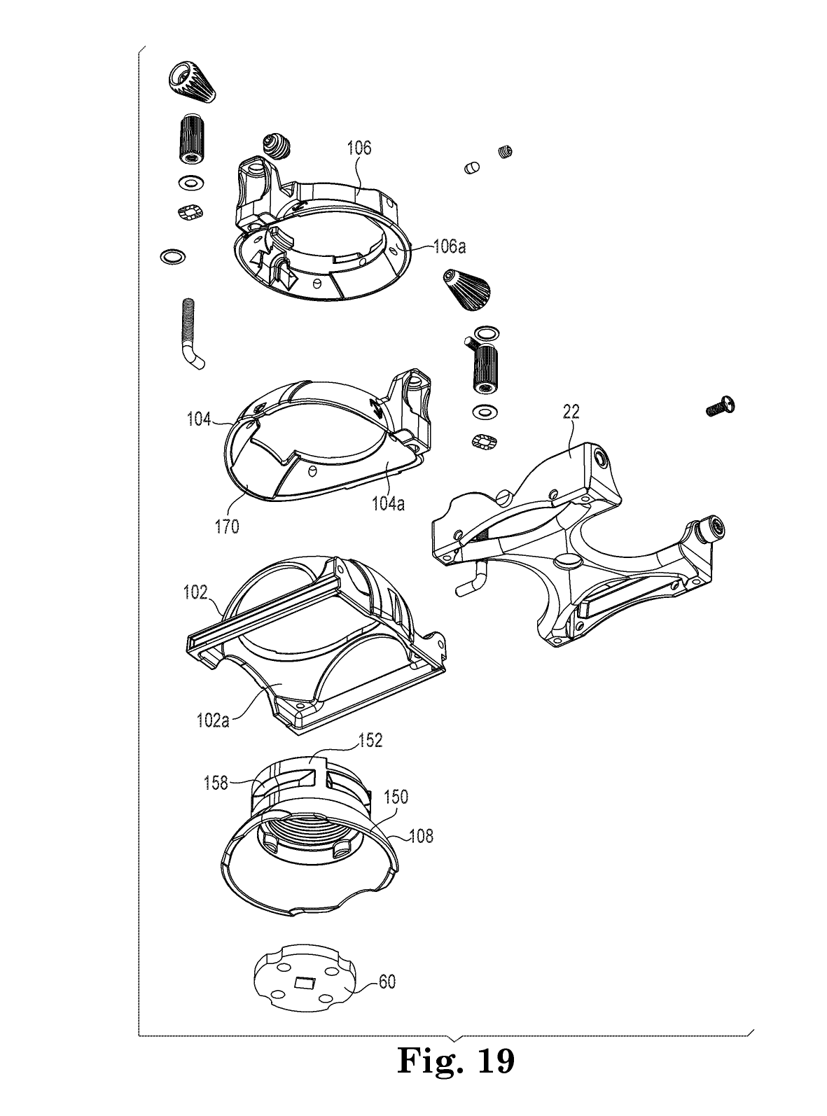

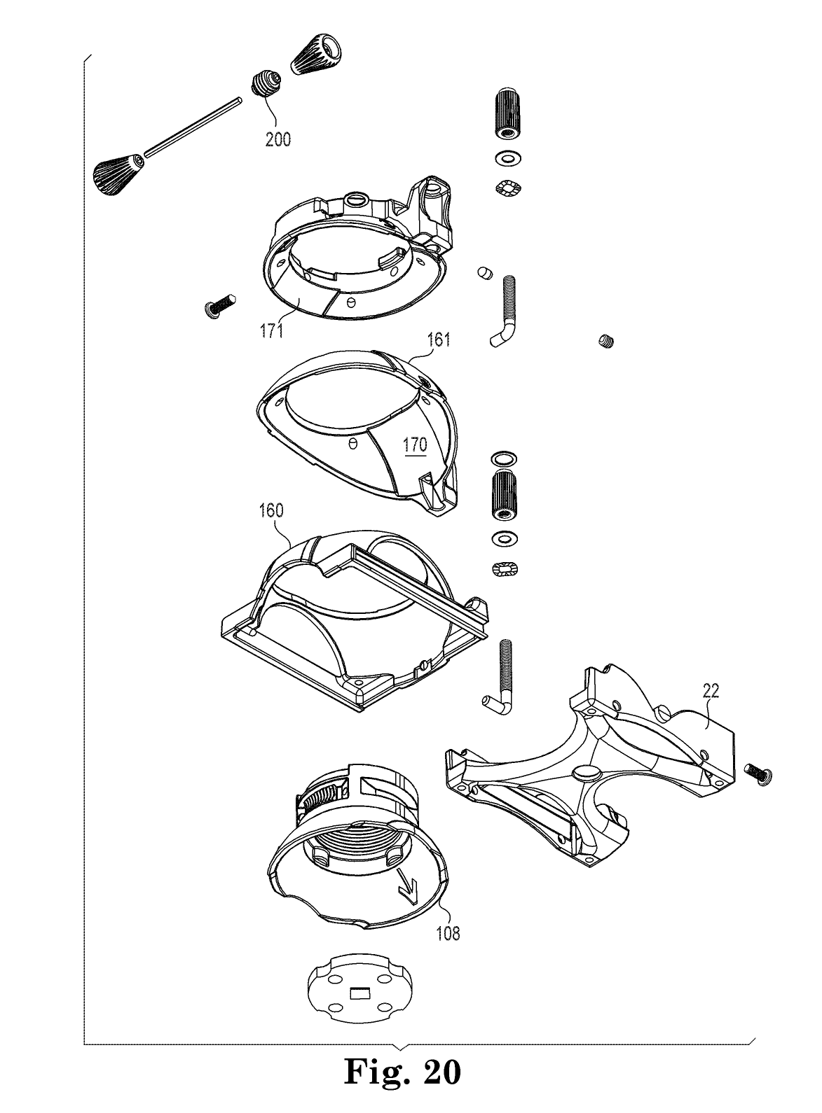

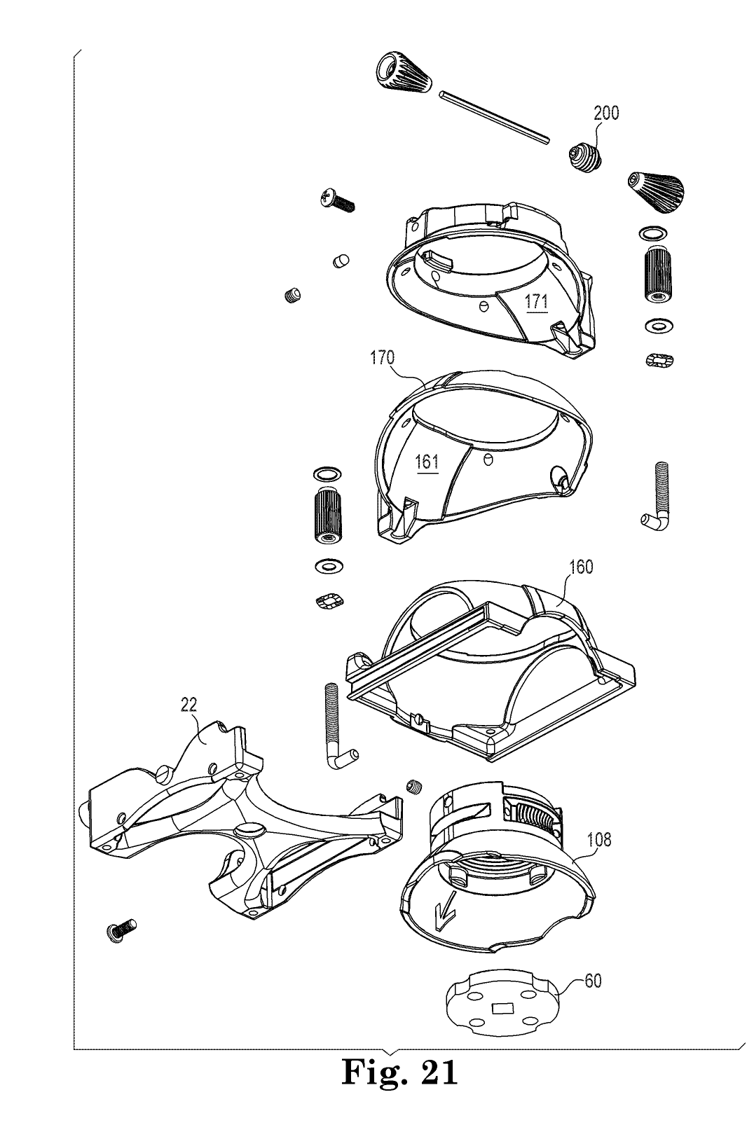

Around the periphery of collar stem 152 are a pair of opposed recesses 154 (see FIG. 18) and a threaded rack portion 156 and its opposing bearing recess 158 (FIG. 19). These surfaces mate with other components as will be explained herein.

Straddling collar stem 152 and slideably engaging flange 150 is a hemispherical base element 102 which has an interior surface shaped to slideably engage with flange 150. The curvature of the inside surface of base 102 and flange 150 are preferably nearly identical so that the maximum number of contacts points exist, thereby reducing the opportunity for wobble and by spreading the force across a larger surface area, the friction at each point.

The outer surface of base 102 also includes a guide 160 in the form a pair of spaced apart ridges which forms guideways in connection with controlling the movement path of the intermediate unit 104. Guides 160 are shown as ridges but could be depressions, tracks or any other form of guideway that runs toward the central aperture.

The base guideway 160 mates with a like guide 170 (FIG. 19) in intermediate element 104. In this case it is a mating depression but it can be any type so long as it mates and runs longitudinally toward the aperture. It could follow a curved path also, or a path which is straight but not longitudinal if the objective would be to combine two of the three directional controls. Between the intermediate element 104 and top element 106, guides 161 mate with guide 171 (see FIG. 20). In the preferred embodiment, the guides are in pairs on both sides of the hemisphere (180 degrees apart) and axially aligned with the adjuster for that hemisphere, so that an axis runs thru the adjuster and guide.

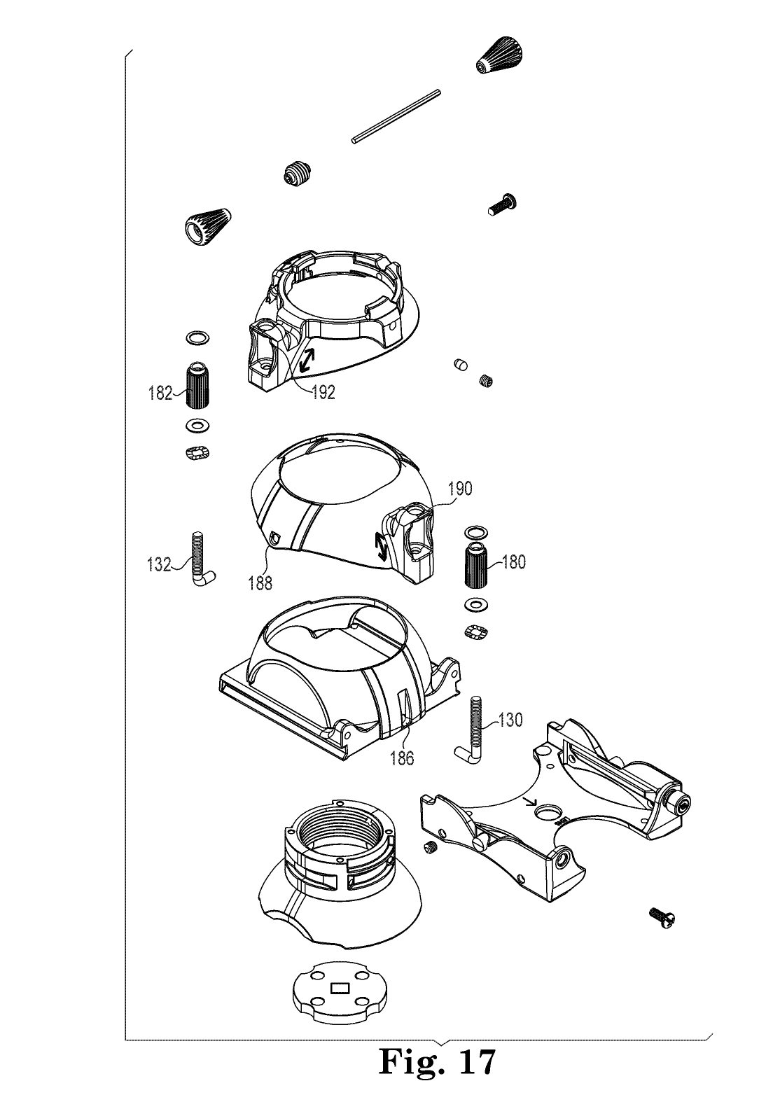

Adjustment of the relative positions of the base and intermediate units is more or less the same in the preferred embodiment. A bolt/nut system is used with L-shaped screws/bolts 130 and 132 being driven by knurled nuts 180/182. the L-shaped screw/bolts are slidingly captured in apertures 186, 188 (FIG. 17) and knurled nuts 180, 182 are captured in their associated unit by shaft mounts 190, 192 which receive the longer portion of the L-shaped screw and capture it as shown in the figures. See FIG. 15. Other forms of adjusters can be substituted for the screw/shaft as shown.

When the knurled nuts are turned, the L-bolt is lengthened or shortened and the base, intermediate and top units move relative to each other but their direction of movement is limited by the guideways which preferably limit their movement to a longitudinal path from the “equator” of the hemisphere to the central axis or “poles”. The two adjusters are located on the sides of their respective hemispheres but rotated 90 degrees from each other.

The top hemispherical element 106 sits atop the intermediate element 104 and has an inner surface which is likewise coated with an anti-friction coating. Like the other hemispheres, its inner curvature mates with the intermediate element's outer curvature with substantially the same curvature so as to minimize friction and wobble, increasing bearing surface with maximized contact.

Rotation of the top element 106 is different from the other elements. It controls the movement of the collar element 108 and consequently the movement of the projector. Top element 106 controls the rotation of the collar element 150 by a rack 156 and pinion gear 200 (FIG. 18) which is attached thru a rod 202 to handles 204. To maintain the rack and gear in engagement, there is a bearing 206 inserted thru an aperture the unit body opposite (180 degrees) gear 200. The bearing is a low friction pellet bearing 206 which is biased against the collar 152 by set screw 208 which drives it into the aperture space. Therefore, the collar 152 is suspended between the bearing 206 and the gear 200. Its rotational freedom is limited by a flange extension 210 (FIG. 8) on the top element 106 which engages a curved slot/recess 212 on the collar 154. The circumferential extent of the recess determines the maximum amount of roll of the mount.

All features disclosed in the specification, including the claims, abstracts, and drawings, and all the steps in any method or process disclosed may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. section 112.

1. A mounting and micro adjustment system connecting equipment to a mounting surface, comprising:
a) a domed hemispherical base element, having an inner and outer surfaces and a generally central aperture;
b) a second hemispherical intermediate element having an inner and outer surfaces said inner surface being sized to receive said outer surface of said base element therein, in slideable contact therewith and having a generally central aperture;
c) a third hemispherical top element having inner and outer surfaces, said inner surface sized to receive said outer surface of said intermediate element in slideable contact therewith and having a generally central aperture;
d) a central collar element having a generally cylindrical portion sized to be received thru said central apertures, and a hemispherical outer surface sized to be received at least partly within and in slideable relation with the inner surface of the base element;
e) first guides located between said base and intermediate elements for limiting the movement between said elements along the path defined by said first guides, thereby defining movement in a first orientation;
f) second guides located between said intermediate and top elements for limiting the movement between said elements along a path defined by said second guides, thereby defining movement in a second orientation;
g) third guides located between said top and collar elements for limiting the movement between said elements along a path defined by said second guides, thereby defining movement in a third orientation;
h) first continuous screw adjustable link between said base and intermediate elements, said link configured to move said base and intermediate elements relative to each other along the path of said first guide;
i) second continuous screw adjustable link, offset from said first link by 90 degrees, between said intermediate and top elements, said link configured to move said intermediate and top elements relative to each other along the path of said second guide;
j) third continuous screw adjustable link, offset from at least one of said first or second link by 90 degrees, between said collar and top elements, said link configured to move said collar and top elements relative to each other along the path of said third guide,
so that movement of each link controls the positioning of the collar.

2. The system of claim 1 wherein said first, second and third links control x, y, and z movement of the collar.

3. The system of claim 1 wherein said first, second and third links control pitch, yaw and roll of the collar.

4. The system of claim 1 wherein said first guide include at least one ridge and at least one depression on slideable mating surfaces of said base and intermediate hemispherical elements, and wherein said second guide include at least one ridge and at least one depression on slideable mating surfaces of said intermediate and top hemispherical elements.

5. The system of claim 1 wherein said guides follow a longitudinal path toward the central aperture.

6. The system of claim 1 wherein said third guide include a ring depression and ring ridge between slideable mating surfaces of said top hemispherical element and the collar element.

7. The system of claim 1 wherein said links include an L-shaped element with a major part being adjustably connected to one hemisphere and a minor part being slideably received in an adjacent hemisphere, so that when the link is adjusted, the two adjacent hemispheres are moved along their guides.

8. The system of claim 7 wherein said major part of said links include a threaded portion and wherein the first and second hemispheres include an adjustment nut with a threaded aperture sized to receive said threaded portion and wherein said nut is rotatably captured on one of said hemispheres, so that rotation of the nut moves the link thereby moving one hemisphere in relation to the other.

9. A mounting and tightening tool system for a projector mount comprising:
a. a mount having an inner and outer surface and a central aperture defining a central axis; and a threaded pipe receiving fixture at said central aperture to be mounted along said central axis;
b. said inner surface including a plurality of engagement members spaced around said aperture;
c. an installation tool sized and shaped to be removeably received within said inner surface and having mating members sized and shaped to received said engagement members, said tool including a central keyed aperture sized to receive a cranking tool
so that, when said tool is inserted into said inner surface it mates with said engagement members and can be rotated by said cranking tool so that said mount is threaded onto said pipe without applying force to the outer surface of the mount.

10. The tool system according to claim 9 wherein said engagement members are a plurality of protrusions toward a central axis and wherein the engagement members on said tool include a plurality of recesses sized and positioned to receive said protrusions.

11. A combination and tightening tool system for affixing a projector mount to a fixed surface, comprising:
a. a mount having an inner and outer collar surface and a pipe threaded receiving central aperture defining a central axis;
b. said inner surface including a plurality of engagement members spaced around said aperture;
c. an installation tool sized and shaped to be removeably received within said inner surface and having mating members sized and shaped to received said engagement members, said tool including a central keyed aperture sized to receive a cranking tool and at least one other aperture therethrough;
so that the tool has two modes of use, either when said tool is inserted into said inner surface it mates with said engagement members and can either be rotated by said cranking tool so that said mount is threaded onto said pipe without applying force to the outer surface of the mount, or when the tool functions as a mounting plate by pressing the mount to the fixed surfaces when the tool is affixed to the surfaces through at least one aperture.

12. The tool system according to claim 11 wherein said engagement members are a plurality of protrusions toward a central axis and wherein the engagement members on said tool include a plurality of recesses sized and positioned to receive said protrusions.
